(19) United States
(12) Patent Application Publication
(10) Pub. No.: US 2025/0220703 A1
(43) Pub. Date: Jul. 3, 2025

(54) PREEMPTIVE TRANSCEIVER PHYSICAL LAYER (PHY) ENHANCEMENTS FOR DETERMINISTIC TRAFFIC

(71) Applicant: Cisco Technology, Inc., San Jose, CA (US)

(72) Inventors: Sivadeep R. KALAVAKURU, Pleasanton, CA (US); Ardalan ALIZADEH, Campbell, CA (US); Matthew A. SILVERMAN, Shaker Heights, OH (US)

(21) Appl. No.: 18/797,427

(22) Filed: Aug. 7, 2024

Related U.S. Application Data
(60) Provisional application No. 63/615,664, filed on Dec. 28, 2023.

(51) Int. Cl. H04W 74/02; H04W 84/12

(52) U.S. Cl. CPC H04W 74/02; H04W 84/12

(57) ABSTRACT

The present disclosure provides techniques for preemptive transceiver PHY enhancements for deterministic traffic. A wireless device stores one or more physical layer (PHY) parameters determined when receiving a first wireless frame from a station (STA). The wireless device identifies a future time when the STA will transmit wireless data to the wireless device. Before the future time, the wireless device configures a PHY in the wireless device based on the one or more PHY parameters. The wireless device receives, using the configured PHY, a second wireless frame from the STA during the future time.

### CROSS-REFERENCE TO RELATED APPLICATIONS

This application claims benefit of co-pending U.S. provisional patent application Ser. No. 63/615,664 filed Dec. 28, 2023. The aforementioned related patent application is herein incorporated by reference in its entirety.

### TECHNICAL FIELD

Embodiments presented in this disclosure generally relate to wireless communication. More specifically, embodiments disclosed herein relate to preemptively configuring an access point's (AP) physical layer (PHY) parameters for predetermined uplink traffic.

### BACKGROUND

Wi-Fi deterministic traffic methods are designed to ensure predictable and reliable data transmission in wireless networks, especially in applications where low latency and high reliability are important. Examples of these methods include Time-Sensitive Networking/IEEE 802.11Qbv, Trigger-Based Uplink Orthogonal Frequency Division Multiple Access (TB UL OFDMA), Restricted Target Wake Time (R-TWT), and Quality of Service (QoS) mechanisms. These methods employ various techniques to prioritize and manage network traffic effectively. One key aspect is the communication of time-aware scheduling by devices with their associated APs, allowing the APs to determine future uplink transmissions from these devices. By knowing the precise timing of data transmission, APs can efficiently allocate resources to minimize collisions and ensure timely delivery of data packets. The deterministic techniques effectively reduce latency and improve the overall performance of the network.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example wireless device with a chipset and a front end module configured to perform various aspects of the present disclosure, according to some embodiments of the present disclosure.

FIG. 2 depicts an example sequence of interactions between an AP and its associated STA for the preemptive configuration of PHY parameters, according to some embodiments of the present disclosure.

FIG. 3 depicts an example method for an AP preemptively adjusting hardware and software settings for predetermined uplink traffic, according to some embodiments of the present disclosure.

FIG. 4 is a flow diagram depicting an example method for preemptive transceiver enhancements for deterministic traffic, according to some embodiments of the present disclosure.

FIG. 5 depicts an example computing device configured to perform various aspects of the present disclosure, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including storing, at a wireless device, one or more physical layer (PHY) parameters determined when receiving a first wireless frame from a station (STA), identifying a future time when the STA will transmit wireless data to the wireless device, configuring, before the future time, a PHY in the wireless device based on the one or more PHY parameters, and receiving, using the configured PHY, a second wireless frame from the STA during the future time.

Other embodiments in this disclosure provide one or more non-transitory computer-readable media containing, in any combination, computer program code that, when executed by operation of a computer system, performs operations in accordance with one or more of the above methods, as well as a system of a wireless device comprising one or more computer processors, and one or more memories collectively containing one or more programs, which, when executed by the one or more computer processors, perform operations in accordance with one or more of the above methods.

### Example Embodiments

The development of deterministic traffic methods has made data transmission in wireless networks more reliable and predictable. These methods use various techniques to prioritize and manage network traffic effectively. One example is IEEE 802.11Qbv/Time-Sensitive Networking, which introduced time-aware scheduling to provide deterministic communication within a Wi-Fi network. This allows traffic with high priority, such as real-time video or industrial automation data, to be transmitted with low latency. Another example is TB UL OFDMA, which enables Wi-Fi devices to efficiently share the uplink channel, to ensure that transmissions occur at specific times or in response to triggers. It improves network predictability and reduces contention.

Additionally, R-TWT is another example that enables devices to use spectrum more efficiently by saving time and making channel access more deterministic. R-TWT-supporting devices will end their transmission opportunity (TXOP) before a protected TWT service period (SP) starts for another device, helping to reduce interference from clients that are transmitting beyond their allotted time period in TWT. Furthermore, Quality of Service (QoS) mechanisms prioritize traffic based on its criticality. By assigning different levels of importance to different types of data, Wi-Fi networks can ensure deterministic delivery for applications that require it.

These deterministic methods typically facilitate communication between a device and its associated AP, enabling the AP to anticipate upcoming uplink data transmission from the device. Since the scheduling is predetermined, the reliability and efficiency of data transmission may be further improved if the AP's transceiver configurations, such as low noise amplifier (LNA) gain and receive start of packet (RX-SOP) threshold, are preemptively adjusted.

The present disclosure introduces techniques for preemptively adjusting PHY parameters within an AP's transceiver to better support deterministic traffic. In some embodiments, the disclosed method may include the AP analyzing uplink signals from a device to determine suitable PHY parameters. With the knowledge of expected future transmissions from the same device (as determined using deterministic techniques, like TB UL OFDMA), the AP may preconfigure its relevant transceiver settings for optimized data handling using the previously determined PHY parameters. Through this preemptive configuration, the AP may be set up to efficiently handle the next signal from the same STA before the signal even arrives. Such proactive adjustment may further minimize (or at least reduce) the residual error vector magnitude (EVM), and ensure any necessary corrections, such as those applied during preamble processing, are more effectively implemented after receiving the signal. This may not only enhance the overall signal-to-noise ratio (SNR) and the detectability of physical layer protocol data unit (PPDUs), but also improve the likelihood of accurate detection and decoding in the presence of undesired signals, interferences, and collisions. Therefore, the embodiments described herein may effectively improve the reliability and efficiency of data transmission in a wireless network.

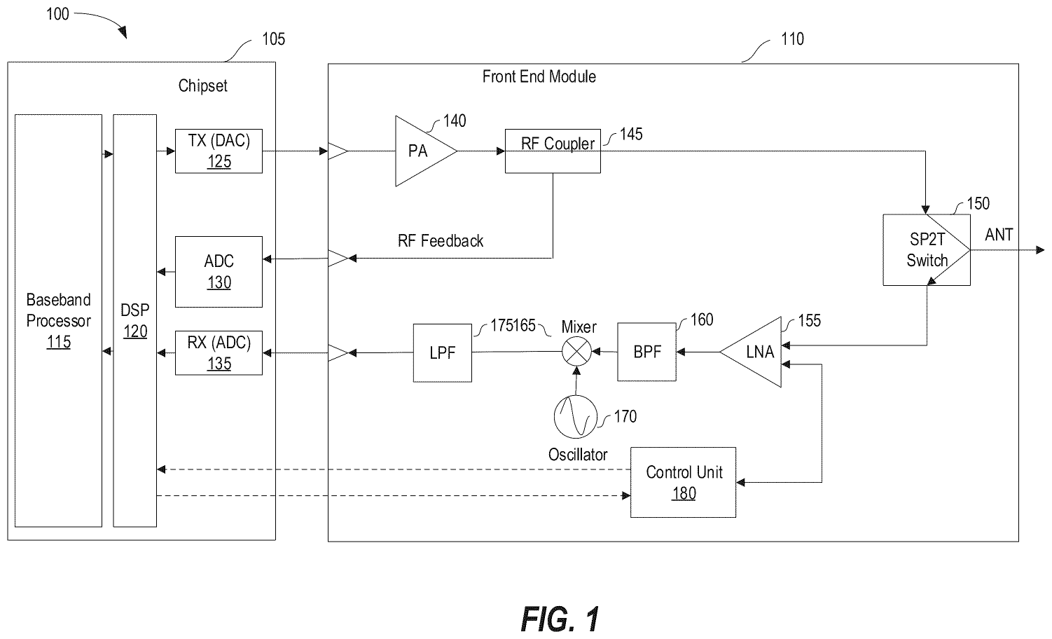

FIG. 1 depicts an example wireless device 100 with a chipset 105 and a front end module 110 configured to perform various aspects of the present disclosure, according to some embodiments of the present disclosure. In some embodiments, the wireless device 100 may correspond to an access point (AP), a router, or a station (STA).

As illustrated, the example wireless device 100 consists of a chipset 105 and a front end (FE) module 110. The chipset 105 includes a baseband processor 115, a digital signal processor (DSP) 120, a transmitter (TX) 125, an analogy-to-digital converter (ADC) 130, and a receiver (RX) 135. In some embodiments, the chipset 105 may also be referred to as the Radio Frequency Integrated Circuit (RFIC).

The baseband processor 115 is configured to handle the lower layers of the communication protocol stack. For transmitting a signal from the example wireless device 100 to another, the baseband processor 115 may perform various operations, such as encoding, modulation, and protocol management, to convert digital data into a format suitable for wireless communication. As depicted, the encoded signal is then sent to the DSP 120, where advanced signal processing operations are performed, such as error correction or modulation adjustments to ensure robust transmission. The processed digital signal is passed by the DSP 120 to the TX 125, which converts the digital signal into an analog signal. In some embodiments, the TX 125 may correspond to a digital-to-analog converter (DAC). In some embodiments, the DSP 120 may correspond to a computing device, such as a microcontroller, a Field-Programmable Gate Array (FPGA), or an embedded computer. In some embodiments, the DSP 120 may run specialized software for signal processing tasks, such as error correction, signal modulation and demodulation.

As depicted, the analog signal is transmitted to the power amplifier (PA) 140 in the FE module 110. The PA 140 amplifies the analog signal to a level suitable for transmission over the air. The amplification ensures that the signal is strong enough to travel long distances and reach the intended receiver (e.g., a STA) with sufficient power. The RF coupler 145 receives the boosted signal. Part of the boosted signal is sampled by the RF coupler 145, and transmitted to the ADC 130 for monitoring and feedback purposes. The sampled signal is then converted into a digital signal and provided to the DSP 120 for further error correction and/or modulation adjustments. The remaining portion of the boosted signal is directed by the single pole double throw (SP2T) switch 150 towards the antenna, which transmits the signal to the intended receiver.

In the illustrated example wireless device 100, the SP2T switch 150 is configured to route the signal between the transmit and receive modes. In the transmit mode, the SP2T switch 150 directs the signal transmitted from the TX 125 to the antenna, and in the receive mode, the SP2T switch 150 directs the signal received from the antenna to the RX 135. In some embodiments, the wireless device 100 may correspond to an AP. In such a configuration, the received signal by the AP 100 may be referred to as an uplink signal, and the transmitted signal by the AP 100 may be referred to as a downlink signal.

As illustrated, the received uplink signal is directed to the low noise amplifier (LNA) 155. A control unit 180 is coupled to the LNA 155 to monitor the strength (e.g., received signal strength indicator (RSSI)) of the received signal, and automatically adjust the gain of the LNA. In some embodiments, the control unit 180 may correspond to an automatic gain control (AGC) circuitry. By adjusting the gain level, the LNA 155 may boost the received signal to a desired power range that ensures the signal can be effectively processed and decoded by the subsequent stages, leading to accurate and reliable data extraction from the received signal.

In some embodiments, the control unit 180 may forward the measured signal strength (RSSI) information to the DSP 120. The DSP 120 may use the information to perform advanced signal processing operations, including calculating the link budget for the device (e.g., a STA) transmitting the current uplink signal. Based on the link budget analysis, the DSP 120 may determine the signal-to-noise (SNR) needed to decode the signal accurately, and may send control signals back to the control unit 180 to adjust the gain of the LNA 155 accordingly.

As depicted, after amplification by the LNA 155, the received signal is filtered by the band pass filter (BPF) 160 to remove unwanted frequencies. The signal is then downconverted to baseband frequency by the mixer 165 using the local oscillator 170. The resulting baseband signal is then filtered by the low pass filter (LPF) 175 to remove high-frequency components before being converted into a digital signal by the TX 125. In some embodiments, the TX 125 may correspond to an ADC. As illustrated, the digital signal is sent to the DSP 120 for further processing, such as demodulating the signal to extract modulated data from the carrier signal. In some embodiments, before demodulation, the DSP 120 may perform additional operations to ensure the signal is accurately processed.

For example, in some embodiments, the DSP 120 may determine the channel state information (CSI) related to the received signal. In some embodiment, the CSI may include detailed information about the channel properties, such as amplitude, phase shift, and frequency response. To determine the CSI, in some embodiments, the DSP 120 may perform preamble processing, where the DSP 120 analyzes known pilot signals and training sequences embedded within the preamble of received frames (e.g., from sounding packets). With the CSI, the AP may adjust the received signal to compensate for any distortions caused by the transmission channel.

In some embodiments, the DSP 120 may calculate the carrier frequency offset (CFO) between the received signal (by the example wireless device 100) and the transmitted signal (by a STA). After identifying the CFO, the DSP 120 may apply a digital phase rotation to the received signal to align it with the received signal. In some embodiments, the DSP 120 may calculate the sampling frequency offset (SFO) between the transmitted and received signals. After determining the SFO, the DSP may apply proper corrections to align the sample rate for accurate decoding.

Additionally, in some embodiments, the DSP 120 may use the RSSI information of the received signal to dynamically adjust the local energy detection threshold (RX-SOP). For example, the DSP 120 may reduce the RX-SOP detection threshold to make the example wireless device 100 more sensitive when the RSSI indicates a weak signal (suggesting that the transmitting device is far from the wireless device 100 or has a weak transmitting power). In contrast, the DSP 120 may increase the RX-SOP threshold to avoid processing noise and interference when the RSSI indicates a strong signal (suggesting that the transmitting device is close to the wireless device 100 or has a strong transmitting power). In some embodiments, the adjustment of RX-SOP may further affect the gain level of the LNA 155, where the DSP 120 may send instructions to the control unit 180 to adjust the gain level accordingly.

After the DSP corrects distortions based on the determined PHY parameters (e.g., CSI, CFO, or SFO) and properly demodulates the received signal, the processed data is then forwarded to the baseband processor 115, which handles the final stages of signal processing. In some embodiments, the baseband processor 115 may decode the signal to extract original data, decrypt data if necessary, and manage the higher-layer protocols to prepare the data for delivery to the appropriate application or upper layers in the communication stack.

In some embodiments, the CSI determined by the DSP 120 may also be used in the transmit path to optimize communication. For example, the DSP 120 may use the CSI to adjust the modulation scheme, coding rate, or beamforming direction, or multi-input and multiple-output (MIMO) configurations, to ensure the transmitted signal is optimized for the current channel conditions.

In some embodiments, such as when the wireless device 100 corresponds to an AP, the determined PHY parameters (e.g., RSSI, LNA gain, CSI, CFO, SFO, and RX-SOP) may be saved into storage for future use. Each set of PHY parameters may be associated with a specific STA, and determined by processing the first received uplink signal from that STA. When deterministic techniques are used, which enables the AP 100 to know time-aware scheduling, such as when a specific STA will transmit another uplink signal, the AP 100 may preemptively configure its settings using the saved PHY parameters. For example, based on the knowledge that the signal characteristics from the same STA usually do not change significantly, the DSP 120 within the AP may dynamically adjust the RX-SOP threshold using the RSSI of the first received uplink signal. When the RSSI of the first uplink signal is low, indicating that the STA is far from the AP 100 or has a weak transmitting power, the DSP 120 may lower the RX-SOP threshold to enhance the receiver's sensitivity. When the RSSI is high, suggesting that the STA is close to the AP 100 or has a strong transmitting power, the DSP 120 may increase the RX-SOP threshold to prevent the receiver from being overly sensitive to noise and interference. In some embodiments, based on the measured RSSI of the first signal, the DSP 120 may proactively set the gain level of the LNA even before the next uplink signal is received. When the next signal is captured and converted into a digital format, the DSP 120 may utilize the previously determined CSI, CFO, and/or SFO to fine-tune the signal before demodulation. The storage of previously determined PHY parameters and their retrieval for preconfiguration avoids the necessity for the DSP 120 to go through the entire process of recalculating these parameters for new signals in real time. Therefore, the response time of the AP when processing new signals from the same STA is effectively reduced, improving the overall network performance.

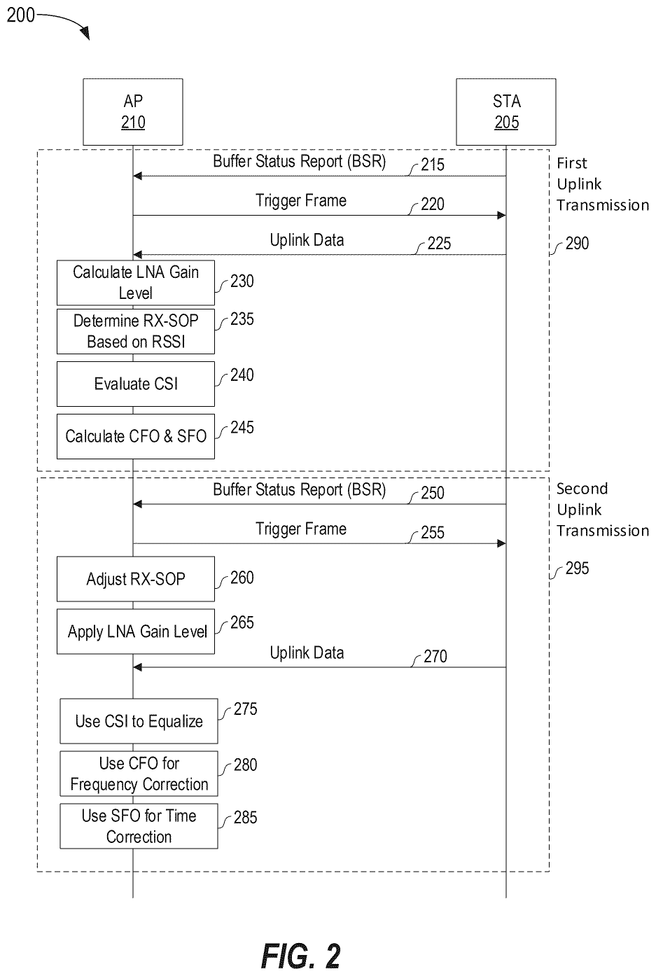

FIG. 2 depicts an example sequence 200 of interactions between an AP 210 and its associated STA 205 for the preemptive configuration of PHY parameters, according to some embodiments of the present disclosure. In some embodiments, the AP 210 may correspond to the wireless device 100, as depicted in FIG. 1. The STA 205 is associated with the AP 210, and uses deterministic methods like TB UL OFDMA to effectively manage uplink transmission. This method allows the STA 205 to request resources from the AP 210 for sending uplink data at a specific time.

As illustrated, to initiate the first uplink transmission, the STA 205 sends a buffer status report (BSR) to the AP 210 (step 215). Within the BSR, the STA 205 indicates the amount of data it has buffered and is ready to be transmitted. Upon receiving the BSR, the AP responds with a trigger frame (TF) (step 220). In some embodiments, the TF may specify the resource units (RUs) allocated for the STA's first uplink transmission and the exact timing for the transmission.

Following the instructions in the TF, the STA 205 modulates the uplink data into a signal, and sends it to the AP 210 using the allocated RUs at the specified time (step 225). After the AP 210 receives the uplink signal, it demodulates the signal and decodes it to extract the original data. To ensure accurate demodulation and decoding, the AP 210 may calculate one or more PHY parameters and apply them to configure the hardware and software components of the AP (steps 230-245). For example, after the signal is received by the AP's antenna, it may be directed to a LNA (e.g., 155 of FIG. 1). In some embodiments, the LNA may be configured to boost the received signal to a level that allows for accurate decoding without causing distortion. To determine the proper gain level that the LNA should apply to the first uplink signal, the AP 210 may measure the received signal's strength (RSSI), and perform a link budget analysis to determine path loss and the SNR that can ensure accurate decoding of the signal. In some embodiments, a variety of factors may be considered during the link budget analysis, including but not limited to, the distance between the STA 205 and the AP 210, the STA's transmission power, and environmental conditions. Based on the measured RSSI, the AP 210 may determine the proper gain level to achieve the desired SNR and adjust the LNA accordingly (step 230). In some embodiments, the AP 210 may further adjust its local energy detection threshold (RX-SOP) based on the received signal strength (step 235). For example, when the signal strength is weak, indicating that the STA 205 is far from the AP 210 or has weak transmission power, the AP 210 may reduce the RX-SOP threshold to make the AP 210 more sensitive to incoming signals. In contrast, when the signal is strong, indicating that the STA 205 is close to the AP 210 or has strong transmission power, the AP 210 may increase the RX-SOP threshold to prevent signal overload. In some embodiments, the adjusted RX-SOP may help to optimize the LNA gain level to maintain balanced signal reception.

In some embodiments, after the signal is properly amplified by the LNA and converted into digital format, the AP 210 may process the received signal to determine the CSI (step 240). As used herein, the CSI may refer to the channel properties and conditions, which indicate how the transmission medium impacts the current uplink signal. To determine the CSI, the AP 210 may analyze the pilot signals and training sequences included within the preamble of the received uplink data. The AP 210 may then use the estimated CSI to equalize the digital signal, compensating for distortions (e.g., multipath propagation) caused by the transmission channel.

In some embodiments, the AP 210 may process the digital signal to estimate the CFO and/or SFO (step 245). As used herein, the CFO refers to the frequency offset between the signal transmitted by the STA 205 and the signal received by the AP 210. The CFO may arise due to slight differences in the local oscillators (e.g., 170 of FIG. 1) used by the transmitter (STA 205) and the receiver (AP 210). The CFO may lead to increased bit error rates (BER) and reduced signal quality. The AP 210 may analyze the pilot signals and training sequences embedded in the uplink data to determine the transmitted signal's frequency (from the STA 205), and compare it against the received signal's frequency to determine the CFO. With the CFO calculated, the AP may generate a correction signal to adjust the frequency of the received digital signal, aligning it with the expected frequency.

As used herein, the SFO may refer to the timing offset between the signal transmitted by the STA 205 and the signal received by the AP 210, which arises due to differences in the sampling clocks of the transmitter (STA 205) and the receiver (AP 210). The SFO may lead to timing errors and signal distortion, therefore further degrading the signal quality. The AP may analyze the timing of pilot signals and training sequences embedded in the uplink data to determine the SFO. Once the SFO is determined, the AP 210 may apply a correction to the sampling process, to ensure the received signal is aligned in time with the transmitted signal from the STA 205.

Following the proper equalization of the digital signal using the CSI, as well as the corrections in frequency and/or timing using CFO and/or SFO, the AP 210 may demodulate the signal and decode it to extract the uplink data. The data may then be forwarded to the application or upper layers for further processing and use. The first uplink transmission is completed when the data is properly received and processed.

If the STA 205 has more data to transmit, it initiates a second uplink transmission. As depicted, the STA 205 sends another BSR report to the AP 210 (step 250). In response, the AP 210 sends a new TF to the STA 205 (step 255), which specifies the new RUs and timing for the second uplink transmission. With the knowledge of the timing and RUs that will be used by the STA 205 in the future time, the AP 210 preconfigures its hardware and software components before the second uplink signal arrives. For example, since the RSSI from the same STA typically does not change significantly over short periods, the AP may adjust the energy detection threshold (RX-SOP) based on the measured RSSI of the first uplink signal (step 260). If the previous link budget analysis reveals that the STA is in the AP's micro or meso cell region, the AP 210 may use the previously determined SNR, and adjust the LNA to the gain level established during the first uplink transmission (step 265). When the AP receives the second uplink signal from the STA using the allocated RUs at the specified time (step 270), the signal may be amplified using the pre-configured LNA gain level without going through the entire calculation process. After the second uplink signal is properly amplified and converted into digital format, it may then be equalized using the CSI determined in the first uplink transmission (step 275). Additionally, the previously calculated CFO may be applied to correct the frequency offset (step 280), and the previously calculated SFO may be applied to ensure time alignment (step 285). By preemptively configuring its settings using the PHY parameters derived from the initial uplink signal, the AP 210 may handle subsequent signals from the same STA more effectively without the need for additional real-time adjustment. This reduces the time required to decode and process each uplink transmission, leading to lower latency and improved signal quality. Additionally, by reusing previously determined PHY parameters, the AP may avoid repetitive calculations for each uplink transmission, allocating its computational power to more valuable tasks and improving the overall network performance.

In some embodiments, the AP may perform all the same calculations using the newly-generated signal metrics for the next (third) uplink transmission. This approach may involve measuring the signal quality metrics such as RSSI or SNR from the second uplink signal, and recalculating the necessary PHY parameters (e.g., LNA gain, RX-SOP, CSI, CFO, and SFO) to ensure optimal (or at least improved) performance for subsequent transmissions. By continuously updating and optimizing these parameters, the AP may adapt to changing conditions and maintain high-quality communication.

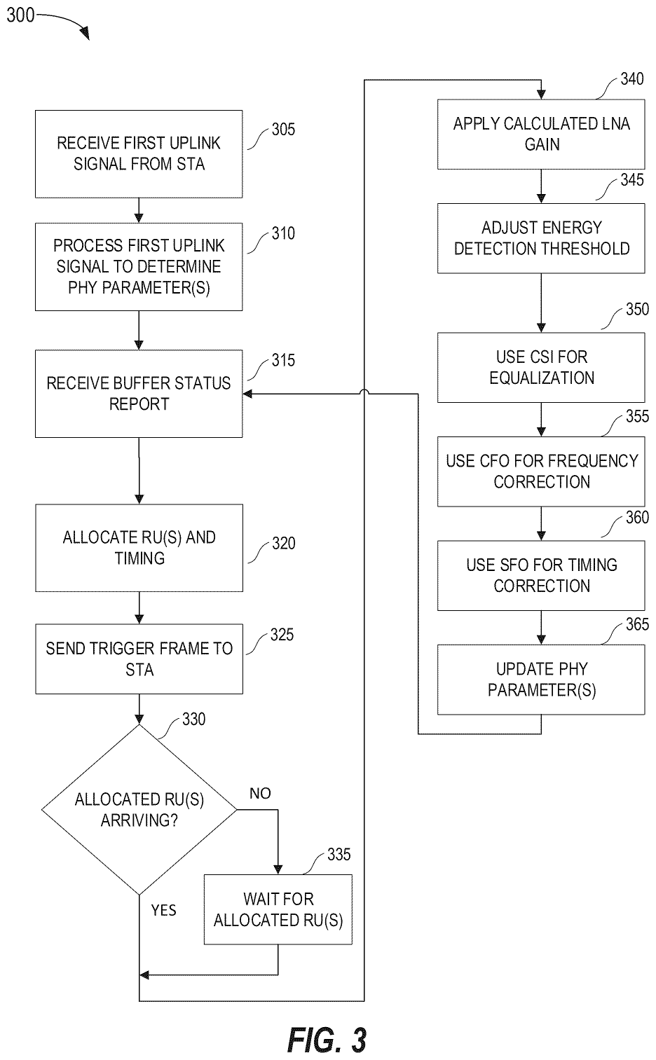

FIG. 3 depicts an example method 300 for an AP preemptively adjusting hardware and software settings for predetermined uplink traffic, according to some embodiments of the present disclosure. In some embodiments, the method 300 may be performed by an AP, such as the wireless device 100 as depicted in FIG. 1, or the AP 210 as depicted in FIG. 2.

At block 305, an AP (e.g., 210 of FIG. 2) receives a first uplink signal transmitted by an STA (e.g., 205 of FIG. 2). In some embodiments, the signal may be captured by the AP's antenna and passed through the AP's transceiver to extract necessary information.

At block 310, the AP processes the signal to determine one or more PHY parameters. In some embodiments, the AP may use a LNA (e.g., 155 of FIG. 1) to amplify the received signal to a level that allows for accurate decoding without causing distortion. To determine the proper gain level, the AP may measure the received signal strength (RSSI), and perform a link budget analysis to determine the SNR that will enable accurate decoding. Based on the RSSI and SNR, the AP may determine the appropriate gain level for the LNA and adjust it accordingly.

In some embodiments, after the signal is amplified and converted into digital format, the AP may perform preamble processing on the received signal to determine CSI, which indicates how the channel impacts the first uplink signal. The preamble of the received frames may include training sequences and pilot signals. By comparing the preamble with expected sequences, the AP may estimate the channel characteristics and determine the CSI. The CSI may then be used to equalize the digital signal and compensate for any distortions caused by the transmission medium.

In some embodiments, the AP may perform preamble processing on the received signal to calculate the CFO and/or SFO. With the CFO and/or SFO, the AP may correct the signal received by the AP, to ensure it is accurately aligned in frequency and/or time with the signal transmitted by the STA.

In some embodiments, the determined PHY parameters may be saved by the AP in storage for future use, such as preemptively configuring its transceiver settings for subsequent transmission from the same STA.

At block 315, the AP receives a BSR from the same STA, indicating that the STA has more data to transmit.

At block 320, based on the BSR, the AP allocates RUs and specifies the timing for the second uplink transmission in the TF.

At block 325, the AP sends the prepared TF to the STA.

At block 330, the AP checks scheduling information to determine whether the transmission slot, which includes the allocated RUs for the STA's second uplink transmission, is arriving. If the transmission slot is arriving, the method 300 proceeds to block 340. Otherwise, the method 300 moves to block 335, where the AP waits for the transmission slot to arrive before proceeding with further actions.

At block 340, the AP applies the previously calculated LNA gain level (during the first uplink transmission, as depicted by block 310) to boost the second uplink signal. The reuse of the previous LNA gain level is based on the assumption that the RSSI from the same STA remains relatively consistent over short periods. In some embodiments, reusing the previously LNA gain level may only occur when the link budget analysis reveals that the STA is within the AP's micro or meso cell region. If the STA is in the cell edge area, the AP may reevaluate the SNR for accurate decoding, and adjust the gain level in real time. This is because RSSI at the cell edge may fluctuate significantly due to factors like greater path loss and increased interference.

In some embodiments, the micro, meso, and cell edge region may be defined by the AP (e.g., 210 of FIG. 2) based on various metrics, such as signal strength, path loss, and interference levels. As used herein, micro region may refer to the region closest to the AP, where signal strength is strong, path loss is minimal, and interference is low. Devices (e.g., STA 205 of FIG. 2) in this region may experience the best possible connection quality. As used herein, the meso region may refer to the intermediate region between the micro region and the cell edge region, where signal strength is moderate and path loss and interference are manageable. Devices in this region may experience good but not optimal connection quality. As used herein, the cell edge region may refer to the region farthest from the AP, with weak signal strength and high path loss and interference level. Devices in this region may experience the poorest connection quality and are most susceptible to changes in signal strength and quality.

At block 345, the AP adjusts the energy detection threshold (RX-SOP) based on the RSSI measured from the first uplink transmission (as depicted by block 310). As used herein, the energy detection threshold may refer to the minimum signal power level required for the AP to consider a signal as valid. The reuse of the previously measured RSSI is based on the presumption that the signal characteristics from the STA remain relatively consistent over short periods. Given the known RSSI from the first uplink transmission, the AP may dynamically adjust the RX-SOP threshold for subsequent transmissions from the same STA to improve signal reception. For example, if the RSSI of the first uplink signal indicates a strong signal, the RX-SOP threshold may be set higher to avoid interference from weaker signals. If the RSS is weak, the threshold may be lowered to ensure the STA's subsequent signal is detected. In some embodiments, the reuse of the previously measured RSSI to adjust the RX-SOP may be limited to situations where the STA is in the AP's micro or meso cell region. In these regions, the signal strengths tend to be more stable and less susceptible to fluctuation. When the STA is at the cell edge, the AP may measure the RSSI in real time since the signal strength at the cell edge may fluctuate significantly due to greater path losses and increased interference.

At block 350, the AP uses the CSI determined during the first uplink transmission (as depicted by block 310) to equalize the second (or subsequent) digital signal. In some embodiments, the CSI may include detailed information about the channel properties, such as amplitude, phase shift, and frequency response. With the CSI, the AP may adjust the amplitude and phase of the received signal to counteract the distortions introduced by the transmission channel. For example, if the CSI determined by processing the first uplink signal indicates a phase shift of a certain degree (e.g., 30 degree), the AP may apply the inverse phase shift (e.g., −30 degree) to the second (or subsequent) signal to cancel out the phase distortion introduced by the channel.

At block 355, the AP uses the previously calculated CFO to correct frequency offset within the second (or subsequent) uplink signal. For example, if the CFO measured from the first uplink signal indicates a 50 MHz offset between the transmitted and received signals, the AP may apply a −50 MHz correction signal to the second digital signal, aligning it with the expected frequency and canceling out frequency-related distortions.

At block 360, the AP uses the previously calculated SFO to correct timing offset within the second (or subsequent) uplink signal. For example, if the SFO measured from the first uplink signal indicates a 0.5% timing offset between the transmitted and received signals, the AP may generate a correction signal that adjusts the sampling rate by −0.5% to align the received signal (by the AP) with the transmitted signal (by the STA). By reusing the previously calculated CFO and/or SFO, the AP saves the time and computational resources required to process the second (or subsequent) signal, improving the AP's efficiency in signal reception and processing. Reusing these parameters assumes that the signal characteristics from the same STA remain relatively stable over short periods. In some embodiments, the reuse of CFO and/or SFO may be limited to situations where the STA is in the AP's micro or meso cell region, where signal characteristics are typically more stable. When the STA is at the cell edge, the CFO and/or SFO may be measured in real time for the second (or subsequent) link for accurate processing.

At block 365, the AP updates the one or more PHY parameters (e.g., RSSI, LNA gain level, RX-SOP, CSI, CFO, or SFO) based on the second uplink transmission. This may involve measuring the final signal quality metrics such as EVM, SNR, and BER to further refine and optimize the configurations for future uplink transmission. By continuously updating these parameters, the AP may adapt to ever-changing network environments, and ensure that its preemptive configurations appropriately amplify and adjust the received signal to a level that allows for accurate decoding. The method 300 returns to block 315, where the AP receives another BSR from the STA for additional uplink data transmission. Using the updated PHY parameters, the AP preconfigures its transceiver settings to handle the next uplink signal.

In the illustrated method, the deterministic method, TB UL OFDMA, is used, through which the AP knows precisely when a specific STA will be sending uplink data, and therefore preconfigures its settings using previously determined PHY parameters. The illustrated method is provided for conceptual clarity. In some embodiments, other deterministic techniques, such as Time-Sensitive Networking/IEEE 802.11Qbv, R-TWT, and QoS mechanism, may be used as long as these techniques enable the AP to determine the timing and characteristics of upcoming signals and adjust its configurations preemptively.

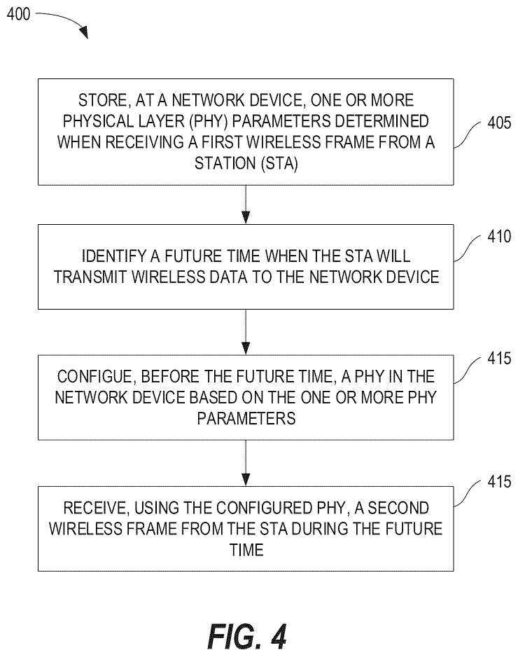

FIG. 4 is a flow diagram depicting an example method 400 for preemptive transceiver enhancements for deterministic traffic, according to some embodiments of the present disclosure.

At block 405, a wireless device (e.g., an AP 210 of FIG. 2) stores the one or more physical layer (PHY) parameters (e.g., RSSI, LNA gain level, CSI, CFO, or SFO) determined when receiving a first wireless frame from a station (STA) (e.g., STA 205 of FIG. 2).

At block 410, the wireless device identifies a future time when the STA will transmit wireless data to the wireless device.

At block 415, the wireless device configures, before the future time, a PHY in the wireless device based on the one or more PHY parameters.

At block 420, the wireless device receives, using the configured PHY, a second wireless frame from the STA during the future time.

In some embodiments, the first and second wireless frames may be transmitted using a deterministic traffic technique for Wi-Fi.

In some embodiments, the wireless device may be an access point (AP), and the PHY may be part of a front end (FE) (e.g., 110 of FIG. 1) of a receiver in the AP.

In some embodiments, to configure the PHY, the AP may set a gain level of a FE amplifier in the receiver based on the one or more PHY parameters.

In some embodiments, the gain level may be determined based on a received signal strength indicator (RSSI) of the first wireless frame.

In some embodiments, the one or more PHY parameters may comprise channel state information (CSI) determined when receiving the first wireless frame. In some embodiments, the AP may further equalize at least a portion of the second wireless frame based on the CSI.

In some embodiments, the one or more PHY parameters may comprise at least one of a carrier frequency offset (CFO) or a sampling frequency offset (SFO) determined when receiving the first wireless frame. In some embodiments, the AP may further correct frequency or timing offset of the second wireless frame using the CFO or SFO.

In some embodiments, the one or more PHY parameters may comprise an energy detection threshold determined based on a RSSI associated with first wireless frame. In some embodiments, to configure the PHY, the AP may adjust the energy detection threshold based on a RSSI associated with first wireless frame.

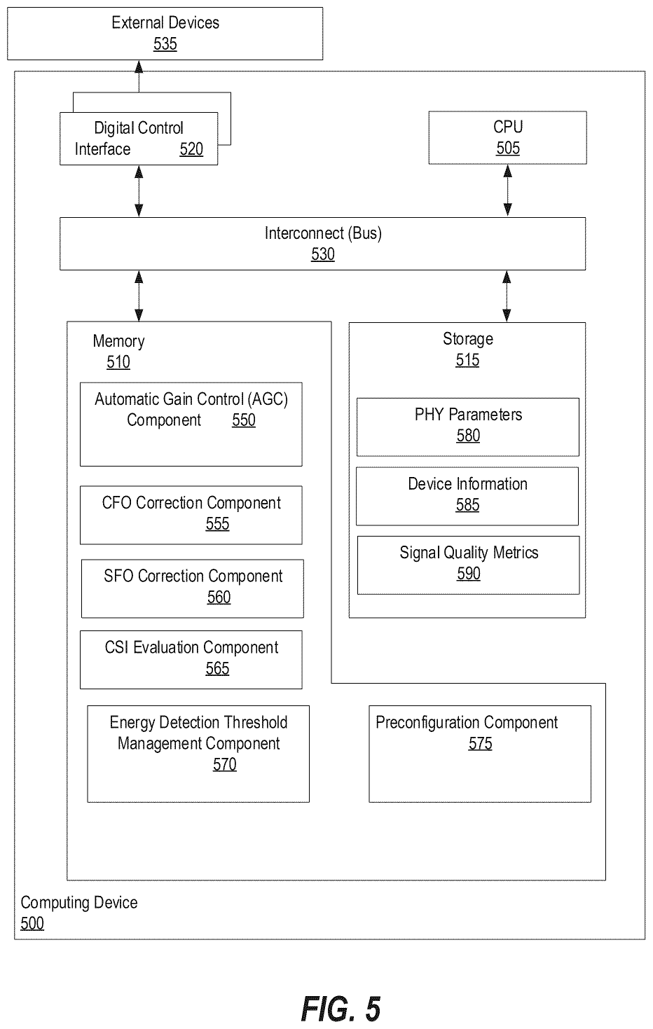

FIG. 5 depicts an example computing device 500 configured to perform various aspects of the present disclosure, according to some embodiments of the present disclosure. In some embodiments, the computing device 500 may correspond to the DSP 120 as depicted in FIG. 1.

As illustrated, the computing device 500 includes a CPU 505, memory 510, storage 515, and one or more digital control interfaces 520. Each of the components is communicatively coupled by one or more buses 530.

The CPU 505 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The CPU 505 retrieves and executes programming instructions stored in memory 510, as well as stores and retrieves application data residing in storage 515. The digital control interface 520 may send control signals to external devices (e.g., the control unit 180 of FIG. 1).

The memory 510 may include random access memory (RAM) and read-only memory (ROM). The memory 510 may store processor-executable software code containing instructions that, when executed by the CPU 505, enable the device 500 to perform various functions described herein for wireless communication. In the illustrated example, the memory 510 includes six software components: the AGC component 550, the CFO correction component 555, the SFO correction component 560, the CSI evaluation component 565, the energy detection threshold management component 570, and the preconfiguration component 575. In some embodiments, the AGC component 550 may interface with other hardware (e.g., the control unit 180 of FIG. 1) to measure the RSSI values of a received uplink signal. Based on the measured RSSI, the AGC component 550 may automatically adjust the gain of the LNA to ensure the signal is amplified to a level for accurate decoding. In some embodiments, the CFO correction component 555 may estimate the frequency offset between the transmitted and received signals. In some embodiments, the estimation may be performed by processing the pilot signals and training sequences embedded in the preamble of uplink data. With the determined CFO, the CFO correction component 555 may apply corrections to match the frequency of the transmitted and received signals. In some embodiments, the SFO correction component 560 may analyze the timing of received signals to determine the SFO, and apply timing corrections to align the received signal's sampling rate with the transmitted signal's rate. In some embodiments, the CSI evaluation component 565 may analyze the preamble of the received uplink signal to determine the channel properties and conditions, and equalize the signal using the CSI to compensate for distortions. In some embodiments, the energy detection threshold management component 570 may adjust the RX-SOP threshold based on the measured RSSI, to ensure the threshold is set to optimize signal reception. In some embodiments, the preconfiguration component 575 may utilize stored PHY parameters (e.g., LNA gain, CSI, CFO, SFO, or RX-SOP) from previous uplink transmissions to optimize settings before the next transmission from the same device arrives.

The storage 515 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 515 may store a variety of data for the efficient functioning of the system. The data may include PHY parameters 580 for configuring the hardware and software components of the wireless device to optimize signal reception and processing (e.g., RSSI, LNA gain, CSI, CFO, SFO, or RX-SOP), device information 585 (including data about the hardware capabilities of connected client device, such as device type, MAC address, and transmitter power), signal quality metrics 590 (including data indicating the performance of the signal processing, such as EVM, SNR, or BER that can be analyzed to update the PHY parameters).

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
storing, at a wireless device, one or more physical layer (PHY) parameters determined when receiving a first wireless frame from a station (STA);
identifying a future time when the STA will transmit wireless data to the wireless device;
configuring, before the future time, a PHY in the wireless device based on the one or more PHY parameters; and
receiving, using the configured PHY, a second wireless frame from the STA during the future time.

2. The method of claim 1, wherein the first and second wireless frames are transmitted using a deterministic traffic technique for Wi-Fi.

3. The method of claim 1, wherein the wireless device is an access point (AP), wherein the PHY is part of a front end (FE) of a receiver in the AP.

4. The method of claim 3, wherein configuring the PHY comprises setting a gain level of a FE amplifier in the receiver based on the one or more PHY parameters.

5. The method of claim 4, wherein the gain level is determined based on a received signal strength indicator (RSSI) of the first wireless frame.

6. The method of claim 1, wherein the one or more PHY parameters comprise channel state information (CSI) determined when receiving the first wireless frame, the method further comprising equalizing at least a portion of the second wireless frame based on the CSI.

7. The method of claim 1, wherein the one or more PHY parameters comprise at least one of a carrier frequency offset (CFO) or a sampling frequency offset (SFO) determined when receiving the first wireless frame, the method further comprising correcting frequency or timing offset of the second wireless frame using the CFO or SFO.

8. The method of claim 3, wherein the one or more PHY parameters comprise an energy detection threshold, wherein configuring the PHY comprises adjusting the energy detection threshold based on a RSSI associated with first wireless frame.

9. A system of a wireless device, comprising:
one or more processors;
one or more memories storing one or more programs, which, when executed on any combination of the one or more processors, performs operations, the operations comprising:
storing one or more physical layer (PHY) parameters determined when receiving a first wireless frame from a station (STA);
identifying a future time when the STA will transmit wireless data to the wireless device;
configuring, before the future time, a PHY in the wireless device based on the one or more PHY parameters; and
receiving, using the configured PHY, a second wireless frame from the STA during the future time.

10. The system of claim 9, wherein the first and second wireless frames are transmitted using a deterministic traffic technique for Wi-Fi.

11. The system of claim 9, wherein the wireless device is an access point (AP), wherein the PHY is part of a front end (FE) of a receiver in the AP.

12. The system of claim 11, wherein, to configure the PHY, the one or more programs, which, when executed by the one or more processors, perform the operations comprising setting a gain level of a FE amplifier in the receiver based on the one or more PHY parameters.

13. The system of claim 12, wherein the gain level is determined based on a received signal strength indicator (RSSI) of the first wireless frame.

14. The system of claim 9, wherein the one or more PHY parameters comprise channel state information (CSI) determined when receiving the first wireless frame, and wherein the one or more programs, which, when executed by the one or more processors, perform the operations further comprising equalizing at least a portion of the second wireless frame based on the CSI.

15. The system of claim 9, wherein the one or more PHY parameters comprise at least one of a carrier frequency offset (CFO) or a sampling frequency offset (SFO) determined when receiving the first wireless frame, and wherein the one or more programs, which, when executed by the one or more processors, perform the operations further comprising correcting frequency or timing offset of the second wireless frame using the CFO or SFO.

16. The system of claim 11, wherein the one or more PHY parameters comprise an energy detection threshold determined, wherein, to configure the PHY, the one or more programs, which, when executed by the one or more processors, perform the operations comprising adjusting the energy detection threshold based on a RSSI associated with first wireless frame.

17. One or more non-transitory computer-readable media containing, in any combination, computer program code, which, when executed by a computer system, performs operations comprising:
storing, at a wireless device, one or more physical layer (PHY) parameters determined when receiving a first wireless frame from a station (STA);
identifying a future time when the STA will transmit wireless data to the wireless device;
configuring, before the future time, a PHY in the wireless device based on the one or more PHY parameters; and
receiving, using the configured PHY, a second wireless frame from the STA during the future time.

18. The one or more non-transitory computer-readable media of claim 17, wherein the first and second wireless frames are transmitted using a deterministic traffic technique for Wi-Fi.

19. The one or more non-transitory computer-readable media of claim 17, wherein the wireless device is an access point (AP), wherein the PHY is part of a front end (FE) of a receiver in the AP.

20. The one or more non-transitory computer-readable media of claim 19, wherein, to configure the PHY, the computer program code, which, when executed by a computer system, performs the operations comprising setting a gain level of a FE amplifier in the receiver based on the one or more PHY parameters.
